(19) United States
(12) Patent Application Publication
(10) Pub. No.: US 2014/0221067 A1
(43) Pub. Date: Aug. 7, 2014

(54) SYSTEMS AND METHODS FOR A CARD GAME

(71) Applicant: High Point Entertainment LLC, Palatine, IL (US)

(72) Inventor: Lawrence J. Hodgson, Kildeer, IL (US)

(73) Assignee: High Point Entertainment LLC, Palatine, IL (US)

(21) Appl. No.: 14/056,272

(22) Filed: Oct. 17, 2013

Related U.S. Application Data
(60) Provisional application No. 61/759,413, filed on Feb. 1, 2013.

(51) Int. Cl. G07F 17/32

(52) U.S. Cl. CPC G07F 17/3293
USPC 463/11

(57) ABSTRACT

The present disclosure provides systems and methods for a game including randomly selecting at least two cards to form a dealer's hand, wherein the number of cards in the dealer's hand displayed face up is determined by a first value associated with a first random event, and wherein a first wager may be equal to a base value modified by a second value associated with a second random event.

### CROSS-REFERENCE TO RELATED APPLICATIONS

This application incorporates by reference and claims priority to U.S. Provisional Application No. 61/759413 filed on Feb. 1, 2013.

### BACKGROUND OF THE INVENTION

The present subject matter relates generally to systems and methods relating to card games.

Card games are popular both socially and for gambling purposes. Poker, and its many variations, is among the most common card game, especially for gambling. The general aim of poker is to collect a hand of cards that is superior to a hand of one or more opponents or dealer, or to try to bet in such a way as to cause opponents to believe that their hand is inferior and subsequently “fold” (concede) their hand. Typically, several players compete against one another or against a dealer for one cumulative “pot” of money.

There are many separate types of games within the poker family, such as Texas Hold'em, Seven-Card Stud, Draw Poker, Hi-low-, and Omaha, all of which provide alternative formats for competing over a five-card hand. Of the many variations of poker, Texas Hold'em is arguably the most popular.

Additionally, there are card-based table games like Three Card Hold'em, Caribbean Stud Poker, Baccarat, and Black Jack that are also popular socially and for gambling purposes. These table games pit one or more players against a dealer where each player's aim is to beat the dealer.

The proliferation of so many variations of card-based poker and table games is an indication that players have an appetite for a wide variety of card-based games. Accordingly, there is a need for providing an exciting variation of card game, as described and claimed herein.

### BRIEF SUMMARY OF THE INVENTION

The present disclosure provides systems and methods relating to card games. Various examples of the system and method are provided herein.

Specifically, the present invention relates to a card game that includes two random events that independently dictate the number of cards displayed face up in a dealer's hand and the wager amount required for a player to remain in the game. The details of the system and method disclosed herein that incorporate the two random events are discussed below.

In an embodiment, the card game system includes a controller and a memory coupled to the controller, wherein the memory is configured to store program instructions executable by the controller. In response to executing the program instructions, the controller is configured to perform a first random event and second random event and display a first value associated with the first random event on a user interface. The controller is further configured to randomly select at least one card to form a player's initial hand and randomly select at least one card to form a dealer's hand. The controller is configured to receive a first wager from a player through the user interface. If the first wager was received, the controller randomly selects at least one card to add to the player's initial hand forming a player's final hand. The first value associated with the first random event determines (a) the number of cards displayed face up in the dealer's hand, or (b) the first wager. The controller is configured to compare the player's final hand to the dealer's hand to determine a winner. In an embodiment, the winner is determined based on standard rules of poker.

The controller may be further configured to perform a second random event, and display a second value associated with the second random event on the user interface. The first wager may be equal to a base value modified by the second value associated with the second random event, and the number of cards displayed face up in the dealer's hand may be determined by the first value associated with the first random event.

In an example, the controller is further configured to receive the base value from a player before randomly selecting at least two cards to form a player's initial hand, wherein the first wager is an amount equivalent to the base value multiplied by the value associated with the second random event. At least one of the first random event and the second random event may include randomly selecting an integer from one to six.

In another example, the controller is further configured to receive a second wager from the player through the user interface before a last card is dealt to form the player's final hand, wherein the second wager is an amount equivalent to the base value multiplied by the value associated with the second random event, and deal a last card to form the player's final hand.

If the player's final hand is determined to be the winner, the controller credits an amount equivalent to the sum of the base value and first wager into an account associated with the player. If the dealer's hand is determined the winner, the controller is configured to debit an amount equivalent to the sum of the base value and first wager from an account associated with the player.

In response to executing the program instructions, the controller may be further configured to compare a second player's final hand to the dealer's hand to determine a winner between the dealer's hand and the second player's hand.

In addition, the controller is configured to randomly select five cards to form a dealer's hand, wherein the number of cards displayed face up is determined by the value associated with the first random event. In one example, if the first value associated with the first random event is one, the dealer's hand includes one card displayed face up and four cards displayed face down. If the first value of the first random event is two, the dealer's hand includes two cards displayed face up and three cards displayed face down. If the first value associated with the first random event is three, the dealer's hand includes three cards displayed face up and two cards displayed face down. If the first value associated with the first random event is four, the dealer's hand includes four cards displayed face up and one card displayed face down. If the first value associated with the first random event is five, the dealer's hand includes five cards displayed face up and zero cards displayed face down. If the first value associated with the first random event is six, the dealer's hand includes zero cards displayed face up and five cards displayed face down.

The present disclosure also provides a method of playing cards. In one embodiment, the method includes performing a first random event and dealing at least one card to form a player's initial hand.

The method further includes dealing at least one card to form a dealer's hand. The method also includes receiving a first wager from a player. An additional at least one card is dealt to the player's initial hand to form a player's final hand, if the first wager was received. The first random event determines (a) the number of cards displayed face up in the dealer's hand, or (b) the first wager. The method includes comparing the player's final hand to the dealer's hand to determine a winner. In an example, the step of comparing the player's final hand to the dealer's hand to determine a winner includes determining the winner based on standard rules of poker.

The method may further include performing a second random event, wherein the first wager is equal to a base value modified by the second random event, and wherein the number of cards displayed face up in the dealer's hand is determined by the first random event. In an example, a first value of the first random event and a second value of the second random event are each independently an integer between and including one through six.

In an example, at least one of the first random event and the second random event includes rolling a die. The method may further include receiving the base value from a player before dealing at least one card into a player's initial hand, wherein the first wager is an amount equivalent to the base value multiplied by a second value of the second random event.

In an example, the method includes receiving a second wager from the player before a last card is dealt to form the player's final hand, wherein the second wager is an amount equivalent to the base value multiplied by a second value of the second random event and dealing a last card to form the player's final hand. In one example, the player's final hand includes five cards.

If the player's final hand is determined to be the winner, the player may receive an amount equivalent to the sum of the base value and the first wager. If the dealer's hand is determined the winner, the dealer may retain an amount equivalent to the sum of the base value and the first wager. In one embodiment, the method includes at least two players.

In one example, if the first value associated with the first random event is one, the dealer's hand includes one card displayed face up and four cards displayed face down. If the first value of the first random event is two, the dealer's hand includes two cards displayed face up and three cards displayed face down. If the first value associated with the first random event is three, the dealer's hand includes three cards displayed face up and two cards displayed face down. If the first value associated with the first random event is four, the dealer's hand includes four cards displayed face up and one card displayed face down. If the first value associated with the first random event is five, the dealer's hand includes five cards displayed face up and zero cards displayed face down. If the first value associated with the first random event is six, the dealer's hand includes zero cards displayed face up and five cards displayed face down.

An advantage of the present invention is that the systems and methods introduce two random events to produce a more exciting card game.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accordance with the present concepts, by way of example only, not by way of limitations. In the figures, like reference numerals refer to the same or similar elements.

FIG. 1 is a schematic of the system according to an embodiment of the invention.

FIG. 2 is a front view of an example of a display on a user interface of the system 10 disclosed herein including a player's initial hand.

FIG. 3 is a front view of an example of a display on a user interface of the system 10 disclosed herein including a first and second wager.

FIG. 4 is a front view of an example of a display on a user interface of the system 10 disclosed herein including a player's final hand that is determined to be a winner.

FIG. 5 is a front view of an example of a display on a user interface of the system 10 disclosed herein including a dealer's hand that is determined to be a winner.

FIG. 6 is a flow chart of the method according an embodiment of the invention.

FIG. 7 is a top view of a game board according to an embodiment of the invention.

### DETAILED DESCRIPTION OF THE INVENTION

The present disclosure provides for systems and methods relating to a card game. Specifically, the present disclosure provides a player with new card game systems and methods that introduce a first and/or second random event in order to provide excitement and novelty to card games, dice games, and board games, among others. For example, with respect to a poker card game, the first random event may be used to determine the number of cards of a dealer's hand that are displayed face up and a second random event may be used to determine a bet multiplier associated with a player's wager. The combination of the two random events into a card game provides players and dealers with a new and exciting game. Although a majority of the examples in the present disclosure are directed to poker-type games, the invention is not limited to poker card games, but rather is applicable to any number of games.

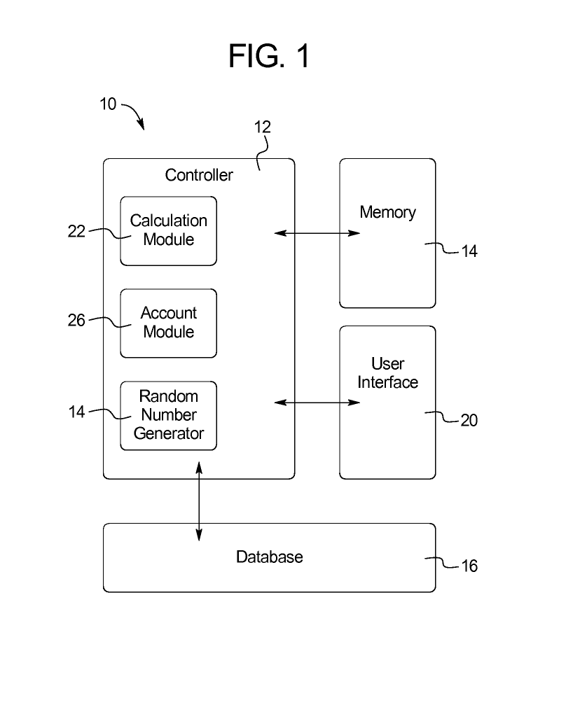

As shown in FIG. 1, the card game system 10 includes a controller 12, a memory 14 coupled to the controller 12, wherein the memory 14 is configured to store program instructions executable by the controller 12. In an example, the controller 12 and memory 14 may be included in a portable electronic user device 18 having a user interface 20. For example, the user device 18 may be a touchscreen-enabled smartphone.

As further shown in FIG. 1, the controller 12 may embody a plurality of modules: a calculation module 22, a random number generator module 24, an account module 26, among others, which are illustrated as discrete elements merely for clarity in the description. It is understood that the modules may be aspects of a game application or may be broken into as many discrete elements as desired for purposes of accomplishing the solutions provided herein.

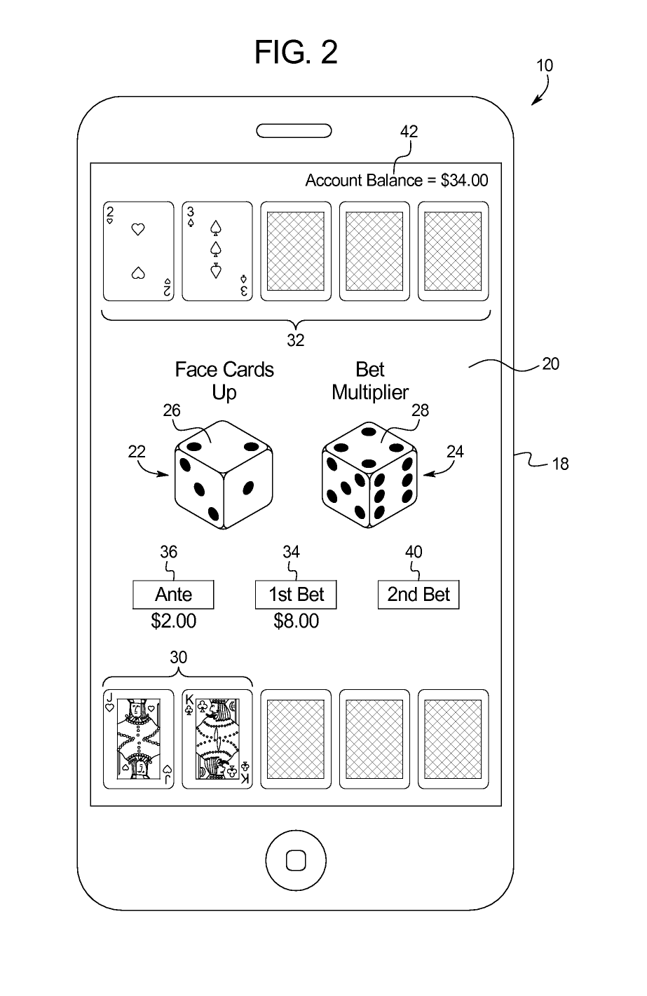

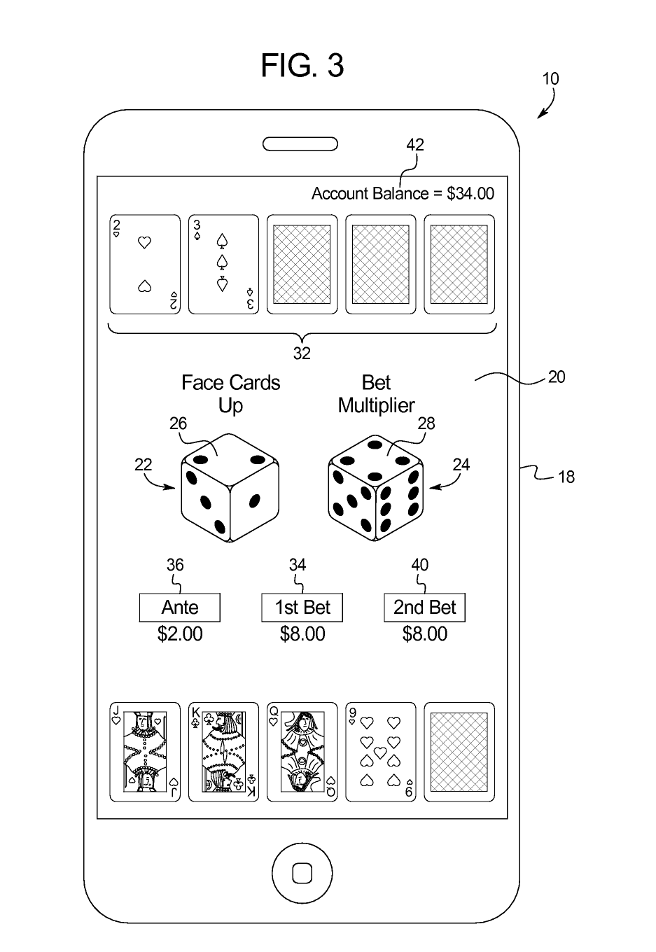

In response to executing the program instructions, the controller 12 is configured to perform a first random event 22 and/or a second random event 24. The controller 12 may be further configured to display a first value 26 associated with the first random 22 event and a second value 28 associated with the second random event 24 on a user interface 20. In one example, the first random event 22 and second random event 24 includes randomly selecting an integer from one to six. Therefore, the first value 26 and second value 28 may independently be an integer between one and six, including the end points one and six. As shown in FIGS. 2 and 3, the controller 12 may be configured to display the first random event 22 and the second random event 24 as rolling virtual dice, wherein a first die may display the first value 26 and a second die may display the second value 28.

The controller 12 is configured to randomly select at least one card to form a player's initial hand 30. For example, in an embodiment shown in FIGS. 2, two cards are selected to form a player's initial hand 30. In another example, three cards may be selected to form a player's initial hand 30. Although, it is contemplated that any number of cards may be selected to form a player's initial hand 30 based on a variety of games.

In addition, the controller 12 is configured to randomly select at least one card to form a dealer's hand 32, wherein the number of cards displayed face up may be determined by the first value 26 associated with the first random event 22. In one example, if the first value 26 associated with the first random event 22 is one, the dealer's hand 32 includes one card displayed face up and four cards displayed face down. If the first value 26 of the first random event 22 is two, the dealer's hand 32 may include two cards displayed face up and three cards displayed face down. If the first value 26 associated with the first random event 22 is three, the dealer's hand 32 may include three cards displayed face up and two cards displayed face down. If the first value 26 associated with the first random event 22 is four, the dealer's hand 32 may include four cards displayed face up and one card displayed face down. If the first value 26 associated with the first random event 22 is five, the dealer's hand 32 may include five cards displayed face up and zero cards displayed face down. If the first value 26 associated with the first random event 22 is six, the dealer's hand 32 may include zero cards displayed face up and five cards displayed face down.

FIG. 2 illustrates an example in which the first value 26 of the first random event 22 is the integer two. Therefore, only two cards of the dealer's hand 32 are displayed face up in FIG. 2. However, it is contemplated that the first value 26 of the first random event 22 does not have a one to one ratio with the number of cards displayed face up. For example, the first value 26 may be an integer between one and eight such that the integers one and two both represent displaying one card face up, integers three and four represent two cards displayed face up, integers five and six represent three cards displayed face up, and integers seven and eight represent four cards displayed face up. Of course, any number of values may be used as the first value 26 that may correspond to any number of cards dealt face up. For example, if the specific game required seven cards in a hand, the first value 26 may be a number between one and seven, and in a one to one ratio with the number of cards displayed face up in the dealer's hand 32. Alternatively, the specific game may require six cards in a hand, and the first value 26 may be selected from the numbers one to ten, with multiple values representing a certain number of cards displayed face up in the dealer's hand 32.

The controller 12 is configured to receive a first wager 34 from a player through the user interface 20, wherein the first wager 34 is equal to a base value 36 modified by the second random event 24. In one example, the base value 36 may be received from a player before the controller randomly selected at least two cards to form a player's initial hand 30. For example, a player may set the base value 36 as two dollars. Alternatively, instead of the controller 12 receiving the base value 36 from a player, the base value 36 may be a pre-set or fixed amount.

In an example, the first value 26 associated with the first random event 22 may determine (a) the number of cards displayed face up in the dealer's hand 32, or (b) the first wager 34, or combinations thereof. For example, the first value 26 may determine the first wager 34. Alternatively, the first value 26 associated with the random event 22 may determine the number of cards displayed face up in the dealer's hand 32, and a the first wager 34 may be determined by the second random event 24.

The first wager 34 may be equal to the base value 36 modified by the second random event 24. In one example, the first wager 34 is equal to the base value 36 multiplied by the second value 28 associated with the second random event 24. For example, if the base value 36 was two dollars and the second value 28 associated with the second random event 24 was four, as shown in FIG. 2, then the first wager 34 would be eight dollars (two times four).

If the first wager 34 is received, the controller 12 is configured to randomly select at least one card to add to the player's initial hand 30 forming a player's final hand 38. Typically, a player's final hand 38 includes five cards. Although, it is contemplated the player's final hand 38 may have any number of cards suitable for a variety of games. For example, the player's final hand 38 may include between, and including, one to fifteen cards, one to ten cards, and one to five cards.

In one example, the controller is configured to display the dealer's hand 32 after a player either folds (i.e., the controller 12 does not receive a first wager 34 or second wager 40) or after a player receives at least one additional card to form the player's final hand 38.

The controller 12 is further configured to compare the player's final hand 38 to the dealer's hand 32 to determine a winner. In one example, the winner is determined based on the standard rules of poker. For example, if a player's final hand 38 includes a full house and the dealer's hand 32 includes a pair of twos, the player's final hand 38 is the winner.

If the player's final hand 38 is determined to be the winner, the controller credits an amount equivalent to the sum of the base value 36 and first wager 34 into an account associated with the player. Alternatively, if the dealer's hand is determined to be the winner, the controller is configured to debit an amount equivalent to the sum of the base value 36 and first wager 34 from an account associated with the player

In addition, the controller 12 may be configured to receive a second wager 40 from the player through the user interface 20 before a last card is dealt to form the player's final hand 38, wherein the second wager 40 is an amount equivalent to the base value 36 multiplied by the value associated with the second random event 24.

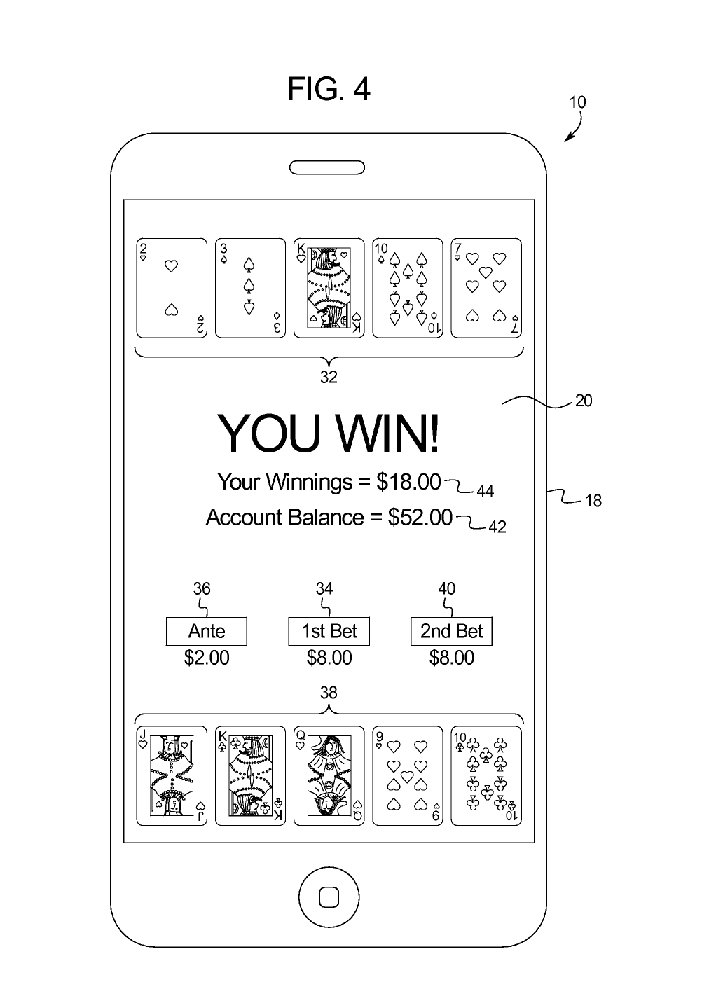

For example, the controller 12 may be configured to randomly select two cards to form a player's initial hand 30, as shown in FIG. 2. If the controller 12 receives the first wager 34, the controller 12 may be configured to randomly select two more cards to add to the player's initial hand 30, as shown in FIG. 3. If the controller 12 receives a second wager 40, the controller 12 may be configured to randomly select a final card to add to the player's initial hand 30 to form the player's final hand 38, as shown in FIG. 4.

If the second wager 40 is not received, the player essentially folds, and the dealer's hand wins. If the player folds after the first wager 34 is received but before the second wager 40 is received, the controller 12 may be configured to debit an amount equivalent to the base value 36 and first wager 34 from an account associated with the player. However, if the second wager 40 is received by the controller 12, a last card is dealt to form the player's final hand 38 and the player's final hand 38 is compared to the dealer's hand 32 to determine a winner. As discussed above, once the last card is dealt to form the player's final hand 38, the controller may be configured to display all of the cards in the dealer's hand 32.

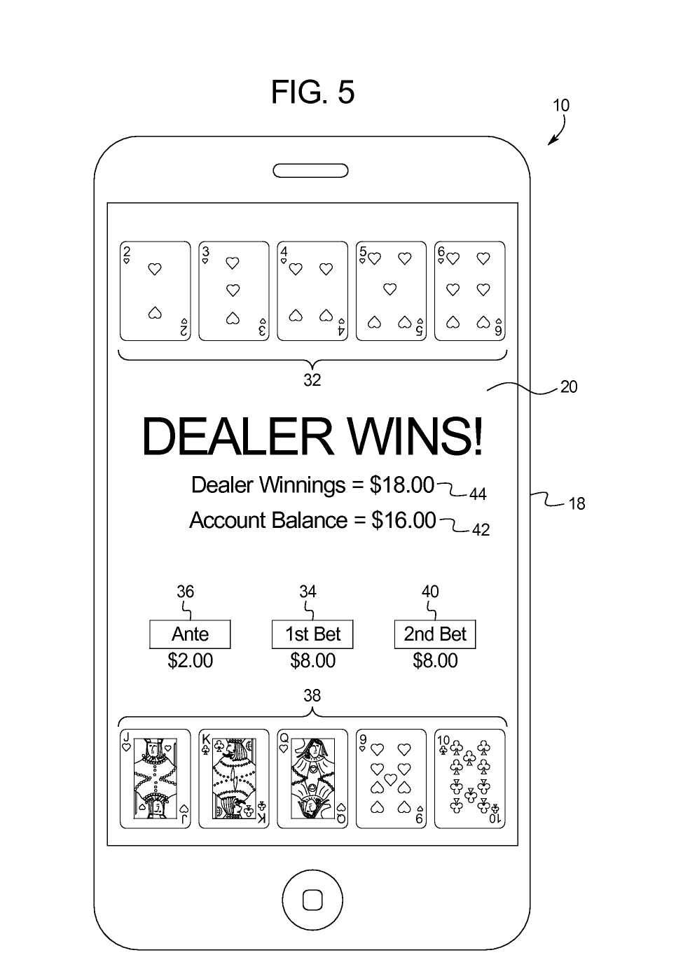

As shown in FIG. 4, if the player's final hand 38 is determined to be the winner, the controller may credit an amount equivalent to the sum of the base value 36, first wager 34, and second wager 40 into an account associated with the player. Alternatively, as shown in FIG. 5, if the dealer's hand is determined to be the winner, the controller may be configured to debit an amount equivalent to the sum of the base value 36, first wager 34, and second wager 40 from an account associated with the player. In the examples shown in FIGS. 2-5, the controller 12 is configured to display an account balance 42 on the user interface 20. As shown in FIGS. 4 and 5, the controller may further be configured to display a game winnings 44, such as the amount credited or debited to a player's account for a particular game or round. Further, the rules of the game and the amount associated with the game winnings 44 may be adjusted to insure a proper return to the player over time and the proper house advantage of at least 97% at perfect play.

It is contemplated that the system 10 may support more than one player simultaneously. For example, the controller 12 may be configured to compare a second player's final hand to the dealer's hand 32 to determine a winner between the dealer's hand 32 and the second player's hand. Alternatively, or in addition to, the controller 12 may be configured to compare a first player's final hand, a second player's final hand, and the dealer's hand 32 to determine one winner among the first player's hand, second player's hand, and dealer's hand.

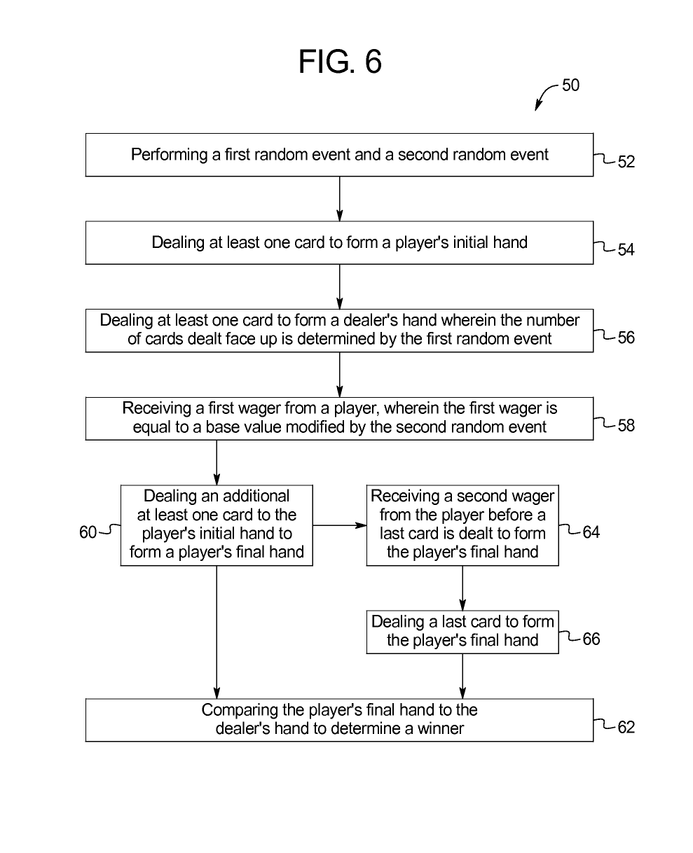

The present disclosure also provides a method 50 of playing cards. In one embodiment shown in FIG. 6, the method includes a first step 52 of performing a first random event 22 and/or a second random event 24. The second step 54 includes dealing at least one card to form a player's initial hand 30. The method 50 further includes a third step 56 of dealing at least one card to form a dealer's hand 32, wherein the number of cards dealt face up is determined by the first random event 22. The method 50 also includes a fourth step 58 of receiving a first wager 34 from a player, wherein the first wager 34 may equal to a base value 36 modified by the second random event 24. Alternatively, the first random event 22 may determine the first wager 34. The fifth step 60 includes dealing an additional at least one card to the player's initial hand 30 to form a player's final hand 38, if the first wager 34 was received. The method 50 includes a sixth step 62 of comparing the player's final hand 38 to the dealer's hand 32 to determine a winner.

In addition, as shown in FIG. 6, the method 50 may include a seventh step 64 of receiving a second wager 40 from the player before a last card is dealt to form the player's final hand 38. If the second wager 40 is received, the eighth step 66 includes dealing a last card to form the player's final hand 38. Once the last card is dealt to form the player's final hand 38, the player's final hand 38 and the dealer's hand 32 are compared to determine a winner.

The method 50 may include dealing an extra card to the dealer's final hand 38. For example, in a game that has a five-card final hand, the method 50 may include dealing a sixth card to the dealer's hand 32. The extra card may only be used if the dealer's hand 32 is not at least one pair or better. If the dealer's hand 32 does not have a pair or better, the dealer may then play the extra card to determine his or her best five-card hand out of the six cards available to the dealer.

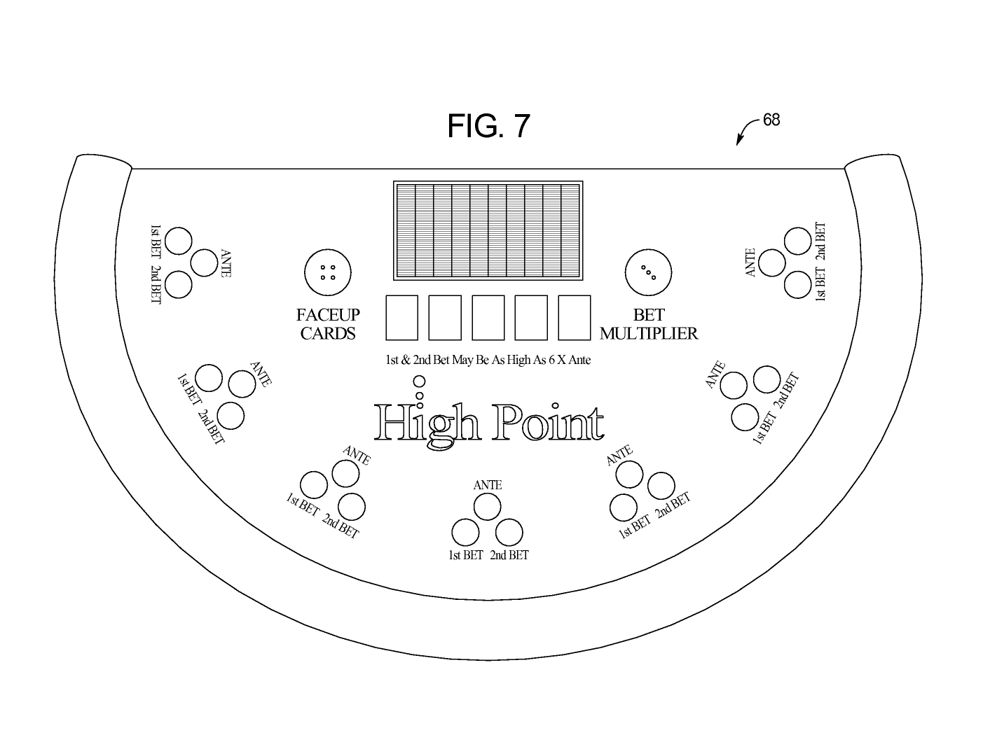

FIG. 7 depicts a game table 68 that may be used in connection with the method, or may be displayed on the user interface 20 as part of the system 10. As shown, the game table 68 includes a receiving space for the dealer's hand 32, the base value or “ante” 36, the first wager 34, and the second wager 40. In FIG. 7, the receiving space for the first wager 34 may be marked “1^{st} Bet” and the receiving space for the second wager 40 may be marked “2^{nd} Bet.” The game table 68 also includes a receiving space for the first value 26 associated with the first random event 22 and a second value 28 associated with the second random event 24. As shown in FIG. 7, the first value 26 may be associated with “Face Up Cards” and the second value 28 may be associated with a “Bet Multiplier.”

The present disclosure includes and applies to various types of games within the poker family, such as Texas Hold'em, Seven-Card Stud, Draw Poker, Hi-low-, and Omaha, all of which provide alternative formats for competing over a five card hand. In addition, the disclosure may apply to table games such as Three Card Hold'em, Caribbean Stud Pocker, Baccarat, and Black Jack, among others.

As mentioned above and schematically shown in FIG. 1, aspects of the systems and methods described herein are controlled by one or more controllers 12. The one or more controllers 12 may be adapted to run a variety of application programs, access and store data, including accessing and storing data in the associated databases 16, and enable one or more interactions as described herein. Typically, the controller 12 is implemented by one or more programmable data processing devices. The hardware elements, operating systems, and programming languages of such devices are conventional in nature, and it is presumed that those skilled in the art are adequately familiar therewith.

For example, the one or more controllers 12 may be a PC based implementation of a central control processing system utilizing a central processing unit (CPU), memory 14 and an interconnect bus. The CPU may contain a single microprocessor, or it may contain a plurality of microprocessors for configuring the CPU as a multi-processor system. The memory 14 may include a main memory, such as a dynamic random access memory (DRAM) and cache, as well as a read only memory, such as a PROM, EPROM, FLASH-EPROM, or the like. The system may also include any form of volatile or non-volatile memory 14. In operation, the memory 14 stores at least portions of instructions for execution by the CPU and data for processing in accord with the executed instructions.

The one or more controllers 12 may also include one or more input/output interfaces for communications with one or more processing systems. Although not shown, one or more such interfaces may enable communications via a network, e.g., to enable sending and receiving instructions electronically. The communication links may be wired or wireless.

The one or more controllers 12 may further include appropriate input/output ports for interconnection with one or more output mechanisms (e.g., monitors, printers, touchscreens, motion-sensing input devices, etc.) and one or more input mechanisms (e.g., keyboards, mice, voice, touchscreens, bioelectric devices, magnetic readers, RFID readers, barcode readers, motion-sensing input devices, etc.) serving as one or more user interfaces 30 for the controller 12. For example, the one or more controllers 12 may include a graphics subsystem to drive the output mechanism. The links of the peripherals to the system may be wired connections or use wireless communications.

Although summarized above as a PC-type implementation, those skilled in the art will recognize that the one or more controllers 12 also encompasses systems such as host computers, servers, workstations, network terminals, and the like. Further one or more controllers 12 may be embodied in a device, such as a mobile electronic device, like a smartphone or tablet computer. In fact, the use of the term controller 12 is intended to represent a broad category of components that are well known in the art.

Hence aspects of the systems and methods provided herein encompass hardware and software for controlling the relevant functions. Software may take the form of code or executable instructions for causing a controller 12 or other programmable equipment to perform the relevant steps, where the code or instructions are carried by or otherwise embodied in a medium readable by the controller 12 or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as the memory 14 of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a controller 12 can read programming code and/or data. Many of these forms of computer readable media may be involved in carrying one or more sequences of one or more instructions to a processor for execution.

It should be noted that various changes and modifications to the embodiments described herein will be apparent to those skilled in the art. Such changes and modifications may be made without departing from the spirit and scope of the present invention and without diminishing its attendant advantages. For example, various embodiments of the method may be provided based on various combinations of the features and functions from the subject matter provided herein.

We claim:

1. A game system comprising:
a controller;
a memory coupled to the controller, wherein the memory is configured to store program instructions executable by the controller;
wherein, in response to executing the program instructions, the controller is configured to:
perform a first random event;
display a first value associated with the first random event on a user interface;
randomly select at least one card to form a player's initial hand;
randomly select at least one card to form a dealer's hand;
receive a first wager from a player through the user interface;
if the first wager was received, randomly select at least one card to add to the player's initial hand forming a player's final hand; and
compare the player's final hand to the dealer's hand to determine a winner,
wherein the first value associated with the first random event determines: the number of cards displayed face up in the dealer's hand; or the first wager.

2. The system of claim 1 wherein the controller is further configured to:
perform a second random event; and
display a second value associated with the second random event on the user interface,
wherein the number of cards displayed face up of the dealer's hand is determined by the first value associated with the first random event,
wherein the first wager is equal to a base value modified by the second value associated with the second random event.

3. The system of claim 2 wherein the controller is further configured to:
receive the base value from a player before randomly selecting at least two cards to form a player's initial hand,
wherein the first wager is an amount equivalent to the base value multiplied by the value associated with the second random event.

4. The system of claim 2 wherein at least one of the first random event and the second random event includes randomly selecting an integer from one to six.

5. The system of claim 2 wherein the controller is further configured to:
receive a second wager from the player through the user interface before a last card is dealt to form the player's final hand, wherein the second wager is an amount equivalent to the base value multiplied by the value associated with the second random event; and
deal a last card to form the player's final hand.

6. The system of claim 1 wherein, if the player's final hand is determined to be the winner, the controller credits an amount equivalent to the sum of the base value and first wager into an account associated with the player.

7. The system of claim 1 wherein, if the dealer's hand is determined the winner, the controller is configured to debit an amount equivalent to the sum of the base value and first wager from an account associated with the player.

8. The system of claim 1 wherein the winner is determined based on standard rules of poker.

9. The system of claim 1 wherein, in response to executing the program instructions, the controller is further configured to compare a second player's final hand to the dealer's hand to determine a winner between the dealer's hand and the second player's hand.

10. The system of claim 1 wherein the dealer's hand includes five cards,
wherein if the first value associated with the first random event is one, the dealer's hand includes one card displayed face up and four cards displayed face down;
wherein, if the first value of the first random event is two, the dealer's hand includes two cards displayed face up and three cards displayed face down;
wherein, if the first value associated with the first random event is three, the dealer's hand includes three cards displayed face up and two cards displayed face down;
wherein, if the first value associated with the first random event is four, the dealer's hand includes four cards displayed face up and one card displayed face down;
wherein, if the first value associated with the first random event is five, the dealer's hand includes five cards displayed face up and zero cards displayed face down; and
wherein, if the first value associated with the first random event is six, the dealer's hand includes zero cards displayed face up and five cards displayed face down.

11. A method of playing a card game comprising:
performing a first random event;
dealing at least one card to form a player's initial hand;
dealing at least one card to form a dealer's hand;
receiving a first wager from a player;
dealing an additional at least one card to the player's initial hand to form a player's final hand, if the first wager was received; and
comparing the player's final hand to the dealer's hand to determine a winner,
wherein the first random event determines the number of cards displayed face up in the dealer's hand; or the first wager.

12. The method of claim 11 further comprising performing a second random event,
wherein the first wager is equal to a base value modified by the second random event,
wherein the number of cards displayed face up in the dealer's hand is determined by the first random event.

13. The method of claim 12 wherein at least one of the first random event and the second random event includes rolling a die.

14. The method of claim 12 further comprising receiving the base value from a player before dealing at least one card into a player's initial hand, wherein the first wager is an amount equivalent to the base value multiplied by a second value of the second random event.

15. The method of claim 12 further comprising:
receiving a second wager from the player before a last card is dealt to form the player's final hand, wherein the second wager is an amount equivalent to the base value multiplied by a second value of the second random event; and
dealing a last card to form the player's final hand.

16. The method of claim 12 wherein, if the player's final hand is determined to be the winner, the player receives an amount equivalent to the sum of the base value and the first wager.

17. The method of claim 11 wherein, if the dealer's hand is determined the winner, the dealer retains an amount equivalent to the sum of the base value and the first wager.

18. The method of claim 11 wherein the step of comparing the player's final hand to the dealer's hand to determine a winner includes determining the winner based on standard rules of poker.

19. The method of claim 12 wherein a first value of the first random event and a second value of the second random event are each independently an integer between and including one through six.

20. The method of claim 11 wherein the dealer's hand includes five cards,
wherein, if a first value associated with the first random event is one, the dealer's hand includes one card face up and four cards face down;
wherein, if a first value associated with the first random event is two, the dealer's hand includes two cards face up and three cards face down;
wherein, if a first value associated with the first random event is three, the dealer's hand includes three cards face up and two cards face down;
wherein, if a first value associated with the first random event is four, the dealer's hand includes four cards face up and one card face down;
wherein, if a first value associated with the first random event is five, the dealer's hand includes five cards face up and zero cards face down; and
wherein, if a first value associated with the first random event is six, the dealer's hand includes zero cards face up and five cards face down.
